(19) United States
(12) Patent Application Publication
(10) Pub. No.: US 2016/0315720 A1
(43) Pub. Date: Oct. 27, 2016

(54) METHOD AND MOBILE STATION FOR BASE STATION MEASUREMENTS

(71) Applicant: TELFONAKTIEBOLAGET LM ERICSSON (PUBL), Stockholm (SE)

(72) Inventor: Sajal Kumar Das, Bangalore (IN)

(21) Appl. No.: 15/103,867

(22) PCT Filed: Dec. 12, 2013
(86) PCT No.: PCT/EP2013/076391

§ 371 Date: Jun. 11, 2016

(51) Int. Cl. H04B 17/318; H04W 36/30; H04W 36/00; H04B 17/345; H04W 24/08

(52) U.S. Cl. CPC H04B 17/318; H04B 17/345; H04W 24/08; H04W 36/0083; H04W 36/30

(57) ABSTRACT

A method in a mobile station for calculating the signal strength of a signal from a first base station is provided. The mobile station receives a plurality of signal samples of an incoming signal. The incoming signal comprises a signal from the first base station and at least one signal from respective at least one second base station. The mobile station also determines a ratio between the total signal strength received from the first base station and interfering signals and noise from the at least one second base station. The ratio is determined based on a standard deviation for the received signal samples. The interfering signals and noise are calculating from the at least one second base station based on a calculated sum of signal strengths for the received signal samples and the determined ratio. The mobile station is further calculating the signal strength of the signal from the first base station based on the calculated interfering signals and noise from the at least one second base station and the sum of signal strengths for the received signal samples.

### TECHNICAL FIELD

Embodiments herein relates generally to a mobile station and a method therein. In particular it relates to measuring a signal strength from a base station.

### BACKGROUND

Wireless devices for communication such as mobile stations (MS) are also known as e.g. User Equipments (UE), mobile terminals, wireless terminals and/or terminals. Mobile stations are enabled to communicate wirelessly in a cellular communications network or wireless communication network, sometimes also referred to as a cellular radio system or cellular networks. The communication may be performed e.g. between two mobile stations, between a mobile station and a regular telephone and/or between a mobile station and a server via a Radio Access Network (RAN) and possibly one or more core networks, comprised within the cellular communications network.

Mobile stations may further be referred to as mobile telephones, cellular telephones, laptops, or surf plates with wireless capability, just to mention some further examples. The mobile stations in the present context may be, for example, portable, pocket-storable, hand-held, computer-comprised, or vehicle-mounted mobile devices, enabled to communicate voice and/or data, via the RAN, with another entity, such as another mobile station or a server.

The cellular communications network covers a geographical area which is divided into cell areas, wherein each cell area being served by a base station, e.g. a Radio Base Station (RBS), which sometimes may be referred to as e.g. “eNB”, “eNodeB”, “NodeB”, “B node”, Base Transceiver Station (BTS), or AP (Access Point), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the mobile stations within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

To support mobile station mobility, cell-reselection and handover mechanisms are implemented in a wireless communications network. This requires periodic measurement by the mobile station of received power from a base station serving the mobile station. The mobile station further needs to measure received power from at least one neighbor base station which neighbor base station is in the vicinity of the mobile station. When the mobile station is switched on, once an appropriate base station is selected and connected as a serving base station, the mobile station enters idle mode. In idle mode the mobile station measures received power from a base station paging channel for any incoming call. The mobile station runs a cell re-selection procedure periodically to check, whether the mobile station is connected to the most appropriate base station or not. This is determined by measuring signal strength and quality of the serving base station and the neighbor base stations.

Generally, a mobile station measures Received Signal Strength Indicator (RSSI) values for a base station and then measure an average RSSI value for that particular base station. The neighbor base stations that should be measured are indicated in a Broadcast control channel Allocation (BA) list. The BA list indicates which broadcast frequencies corresponding to neighbor base stations the mobile station should measure on periodically. The BA list is transmitted on a Broadcast Control CHannel (BCCH). The mobile station continues to monitor all broadcast frequencies from the different base stations as indicated by the BA list. In Idle mode, the mobile station shall implement a cell selection and re-selection procedures to ensure that the mobile station camps on the best suitable base station. For the cell selection and re-selection procedure, the mobile station is required to maintain an average of received signal levels for all measured broadcast frequencies. The measurements of the broadcast frequencies, known as Received Level Averages (RLA_C), are measured in dBm.

When the mobile station is in dedicated mode, such as during a call, the mobile station measures the RSSI and calculate a signal quality value (RxQUAL) for the serving base station and it also measures the RSSI of the neighbor base stations as above and reports to the wireless communications network. In idle mode, the strongest base station is selected based on the RSSI value and the mobile station connects to the strongest base station. Similarly, in the dedicated mode, the mobile station sends a measurement report containing the base station's RSSI measured values to the wireless communications network. If the serving base station's RSSI and RxQUAL value deteriorates then the wireless communications network uses the reported RSSI values from the mobile station to find out the best suitable base station and initiates a hand over to that base station.

A problem is that when the mobile station measures on base stations, the measurements are affected by interference and noise. This will lead to noisy and incorrect measurements.

### SUMMARY

It is an object of embodiments herein to provide an improved way of handling mobility, cell reselection and hand over of a mobile station.

According to a first aspect of embodiments herein the object is achieved by a method in a mobile station for calculating a signal strength of a signal from a first base station. The mobile station receives a plurality of signal samples of an incoming signal. The incoming signal comprises a signal from the first base station and at least one signal from respective at least one second base station. The mobile station determines a ratio between the total signal strength received from the first base station and interfering signals and noise from the at least one second base station. The ratio is determined based on a standard deviation for the received signal samples. The mobile station calculates the interfering signals and noise from the at least one second base station based on a calculated sum of signal strengths for the received signal samples and the determined ratio. The mobile station also calculates the signal strength of the signal from the first base station based on the calculated interfering signals and noise from the at least one second base station and the sum of signal strengths for the received signal samples.

According to a second aspect of embodiments herein the object is achieved by a mobile station for calculating a signal strength of a signal from a first base station is provided. The mobile station is configured to receive a plurality of signal samples of an incoming signal. The incoming signal comprises a signal from the first base station and at least one signal from respective at least one second base station. The mobile station is further configured to determine a ratio between the total signal strength received from the first base station and interfering signals and noise from the at least one second base station. The ratio is determined based on a standard deviation for the received signal samples. The mobile station is further configured to calculate the interfering signals and noise from the at least one second base station based on a calculated sum of signal strengths for the received signal samples and the determined ratio. Finally, the mobile station is configured to calculate the signal strength of the signal from the first base station based on the calculated interfering signals and noise from the at least one second base station and the sum of signal strengths for the received signal samples.

Since it is possible to calculate the signal strength of the signal from the first base station with a minimum of interference from the at least one second base station by basing the calculation on the calculated interfering signals and noise from the at least one second base station and the sum of signal strengths for the received signal samples the handling of mobility cell reselection and hand over in the mobile station is improved.

An advantage with embodiments herein is that it is easier for the mobile station to find the best base station to camp on.

A further advantage with embodiments herein is that also the signal strength of neighbor base stations may be calculated in an improved way.

A further advantage with embodiments herein is that the method is simple and may be used in any radio access technologies.

A further advantage with embodiments herein is that full burst data reception is not needed for calculating the signal strength from the first base station.

A further advantage is that the mobile station does not require any known signal sequence also known as pilot sequences to be present for measuring the Interference or quality of the received signal since the mobile station may measure on the base stations at any time.

A further advantage is that the mobile station may use the measured signal strength for the measured base station for various purposes like, Adaptive Multi-Rate (AMR) codec rate adaption, Cell Signal Quality Indication (CQI) and dynamic equalizer selection for receiver signal processing.

A further advantage is that improved accuracy of the measured base station's signal strength improves the re-selection and handover procedure, leading to better connectivity and lesser call drops.

A further advantage is that the mobile station may quickly detect, whether any constant modulated signal is present in a broadcast frequency.

### BRIEF DESCRIPTION OF THE DRAWINGS

Examples of embodiments herein are described in more detail with reference to attached drawings in which:

FIG. 1A and 1B are constellation diagrams of received signal samples;

FIG. 2 is a schematic block diagram illustrating a wireless communications network;

FIG. 3 is a flowchart depicting embodiments of a method in the mobile station; and

FIG. 4 is a schematic block diagram illustrating the mobile station according to some embodiments.

### DETAILED DESCRIPTION

As part of developing embodiments herein, some problems have been identified and will first be discussed.

In Frequency Division Multiple Access (FDMA), different base stations broadcasts on different frequency bands, also known as broadcast frequencies. Ideally this means that a mobile station listening for the signals of the transmitting base station will only be able to receive signals from one base station on any given location. The same broadcast frequency will be used again by other base stations for signaling based on a frequency re-use factor used by an operator for network deployment, but ideally they will be far away from the mobile station and only very week signals will reach the mobile station from those base stations.

The following description will be described in the context of Global System for Mobile Communication (GSM) but the skilled person will also know that the embodiments also applies to other FDMA systems. GSM is both an FDMA and a Time Division Multiple Access (TDMA) system.

Due to bad network planning in GSM, the broadcast frequencies used by one base station are re-used by a neighbor base station close to the mobile station. That causes high Co-Channel Interference (CCI) in the received signal meaning that signals are received by the mobile station on the same broadcast frequency from different base stations. This is a problem in the periphery of the cell. This has become more severe recently due to bad cell planning and smaller cell sizes.

So, when the mobile station measures a signal strength of a GSM base station, the signal is mixed with signals from other base stations, due to presence of high interference signal in the received signal. This is applicable both when measuring on the serving base station and on the neighbor base stations. This means that the measurements may be wrong. One way to measure the signal strength of a base station is the RSSI.

That leads to wrong measurement result, leading to wrong relative ranking of the measured base stations, not camping on the best base station, handing over to wrong base station etc.

Another issue is that in a Multi-Radio Access Technology (RAT) the mobile station has to monitor several neighbor base stations belonging to different RATs. This limit the time the mobile station may use to measure on each base station. So, MS is scheduled very little time to measure on neighbor base stations. To measure on a base station the mobile station only has time to collect 32 samples corresponding to 32*3.69 microseconds per neighbor base station. Averaging over several such measurements is difficult, due to strict time budget. So, it is desirable that in one single attempt, by receiving 32 signal samples, measure a true RSSI of the base station. And also at the same time measure the quality of neighbor base stations which will be helpful for ranking the quality of the neighbor base stations. This is applicable according to embodiments herein both when measuring signals from the serving base station and the neighbor base stations.

A similar problem arises when the measured RSSI from a base station is mixed with a strong Adjacent Channel Interferer (ACI) signal. To avoid ACI and out of band noise, the received signal from the base station will first be passed through a narrow band filter having a bandwidth which is the same as the required bandwidth of a frequency channel of the wireless communications network, e.g. in case of GSM it will be 200 kHz. The narrow band filter blocks out the ACI signal and the out of band noise signal. But, still the CCI and some parts of the ACI and noise signal may be present in the received signal.

So, for better cell ranking, the mobile station needs to find out the true signal strength for each respective base station i.e. measure and estimate the different base stations signal strength more accurately and free from interference and noise power. This means that the true RSSI may be described as Equation (Eq) 1:

RSSIₜᵣᵤₑ=RSSIₜₒₜₐₗ−(I+N) (Eq 1)

Where, RSSI_{true total} it the true RSSI from the measured base station, RSSI is the total measured RSSI in the broadcast frequency band. I is the interference power from other base stations in the broadcast frequency band and N is noise power in the measured signal.

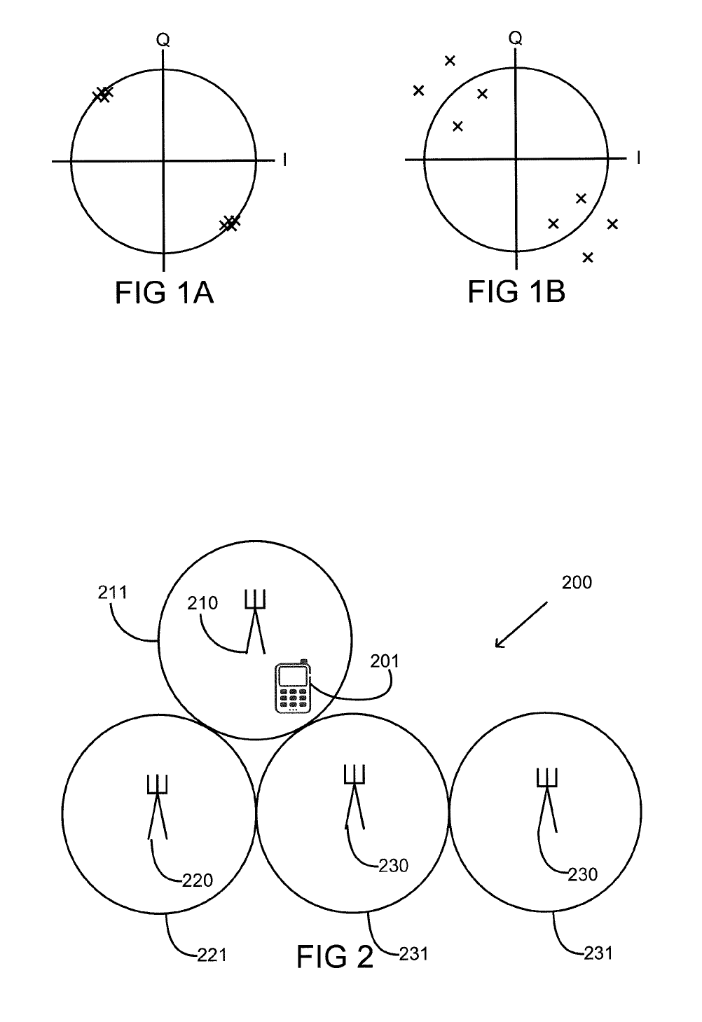

FIG. 1A and FIG. 1B shows constellation diagrams of received signal samples. The mobile station measures the signal strength on a first base station. In GSM, Gaussian Minimum Shift Keying (GMSK) modulation is used meaning that information is transmitted with constant amplitude but with different phases. Ideally this means that all signal samples of the signals transmitted by the base station is always received with constant amplitude by the mobile station. This is illustrated in FIG. 1A. The circle illustrates the constant amplitude. The crosses in FIG. 1A correspond to different signal samples in an I-Q-plane. As seen in FIG. 1A all signal samples are basically received with the same amplitude. The two different groups of signal samples, having different phases, represent a logical one and a logical zero respectively.

Signals from a second base station may interfere with signals from the first base station when the mobile station is measuring the signal strength of the first base station. This is illustrated in FIG. 1B. The signal samples from the first base station are received by the mobile station with higher signal strength than signal samples received from the second base station. Signal samples corresponding to the first base station are thus located further away from the center of the constellation diagram and signal samples corresponding to the second base station are thus located closer to the center of the constellation diagram.

FIG. 2 depicts an example of a wireless communications network 200 according to a first scenario in which embodiments herein may be implemented. The wireless communications network 200 is a wireless communication network such as a GSM network, or any other FDMA wireless communications network.

A mobile station 201 operates in the wireless communications network 200. The mobile station 201 may be a mobile phone capable of using GSM as described above or any other mobile device compliant with the wireless communications network 200 such as a wireless device, a user equipment a mobile wireless terminal, a wireless terminal, a mobile phone, a computer such as e.g. a laptop, a Personal Digital Assistants (PDAs) or a tablet computer, sometimes referred to as a surf plate, with wireless capability, or any other radio network unit capable to communicate over a radio link in a wireless communications network. Please note the term mobile station used in this document also covers other wireless devices such as Machine to machine (M2M) devices.

In FIG. 2 the mobile station 201 is served by a serving base station 210 in the wireless communication network 200. The serving base station 210 serves an area close to the serving base station 210 known as a serving cell 211. The serving base station 210 will be described here as a GSM base station but it may also be any kind of node using FDMA such as a transmission point, a radio base station, an eNB, an eNodeB, a Home Node B, an Home eNode B or any other network node capable to serve a mobile station in a wireless communications network.

The mobile station 201 measures the signal strength of the serving base station 210 both in idle mode, in active mode and in dedicated mode. One way to measure the signal strength of the serving base station 210 is to measure the RSSI.

The wireless communications network 200 also comprises a first base station 220. The mobile station 201 is situated in the vicinity of first base station 220 such that the mobile station 201 is within radio coverage of the first base station 220. The first base station 220 serves an area close to the first base station 220 referred to as a first cell 221. The first base station 220 has basically the same capabilities as the serving base station 210.

As described above the wireless communications network 200 is an FDMA system meaning that neighboring base stations broadcast on different frequencies. The broadcast frequency used by one base station is reused by another base station further away. In FIG. 1 at least one second base station 230 is reusing the same broadcast frequency as the first base station 220. The second base station 230 serves an area close to the second base station 230 referred to as a second cell 231.

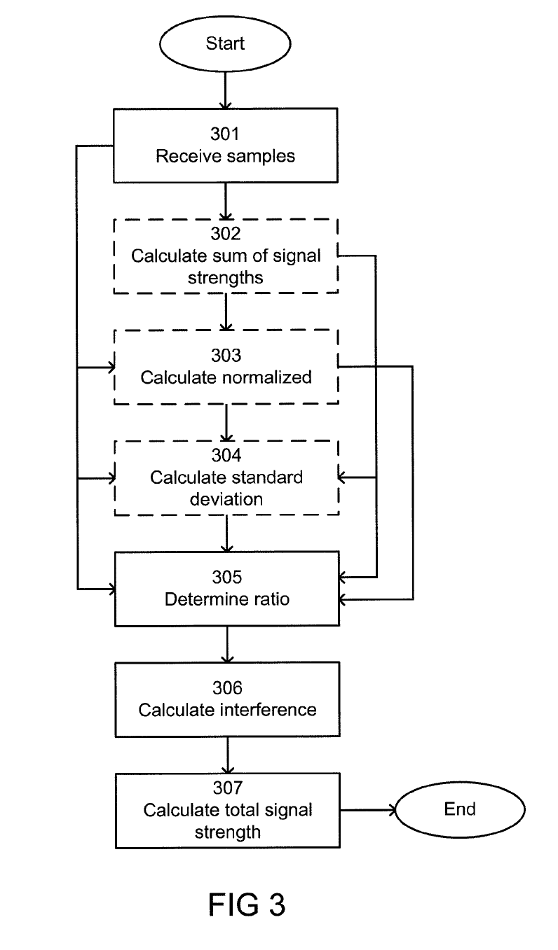

Example of embodiments of a method in a mobile station 201 for calculating a signal strength of a signal from a first base station 220 will now be described with reference to a flow chart depicted in FIG. 3.The method comprises the following actions, which actions may be taken in any suitable order. Dashed lines of one box in FIG. 3 indicate that this action is not mandatory.

Action 301

A plurality of signal samples of an incoming signal is received by the mobile station 201. The incoming signal comprises a signal from the first base station 220 and at least one signal from respective at least one second base station 230.

The mobile station 201 measures the signal strength of the first base station 220 to find candidates for e.g. a possible hand over or re-selection. The mobile station 201 may then store the result in a track list. The track list track is a list of previously measured base stations. If the signal strength of the first base station 220 is higher than the signal strength of the serving station 210 a hand over or a re-selection to the first base station 220 is performed. In the embodiments below, when the mobile station 201 measures signal strengths on the first base station 220 it is understood by the skilled person that the embodiments also relates to when the mobile station 201 measures on the serving base station 210.

Since the second base station 230 is broadcasting on the same broadcast frequency as the first base station 220, signals from the second base station 230 is interfering with the signals from the first base station 220 that the mobile station 201 is measuring on.

When the mobile station 201 measures on a base station such as any of the serving, first or second base stations 210, 220, 230, the mobile station 201 obtains a plurality of signal samples. The signal samples may comprise an I and a Q component. The I and Q indicate the In-phase and Quadrature-phase signal's digital values, received by the mobile station 101.

The signal samples are received via a Radio Frequency (RF) interface of the mobile station 201 according to well-known techniques.

Due to large number of base stations to be measured, the mobile station 201 may only have a very short time for the signal sample collection.

Action 302

The mobile station 201 calculates a sum of signal strengths for the received signal samples. The sum of signal strengths will be used further below.

This may be performed by measuring RSSI of the first base station 220 by programming the RF of the mobile station 201 to the desired broadcast frequency of the first base station 220 and then by receiving the signal samples from the RF. The mobile station 201 may compute the sum of signal strengths of the first base station 220 according to Eq 2:

$${RSSI\_}_{total} = \sqrt{ } ( {\sum }_{m = 0}^{m = M - 1} {I ( m )}^{2} + {Q ( m )}^{2} ) \qquad ( Eq 2 )$$

Where M is the total number of signal samples in the received n-th burst and m indicates the signal sample number in the received signal and m varies from 0 to (M−1). For example in GSM M may be 156 for the whole burst reception. To save measurement time, generally, the mobile station collects only 32 signal samples for signal strength measurement. 32 samples correspond to 32*0.369 microseconds. The mobile station 201 may measure at any time and is not dependent on a time synchronization of the base station. The mobile station does not need to know where known sequences or pilot bits are present to estimate the interference in the received signal.

Action 303

The mobile station 201 may calculate a normalized signal strengths value for the received signal samples based on average signal strengths for the received signal samples. The normalized signal strengths for the received signal samples may be used when calculating the standard deviation below.

As described above each signal sample comprises an I and a Q component. As shown in the FIG. 2A and FIG. 2B above, I=r*cos θ, Q=r*sin θ, where r is the radius of the constant amplitude circle and θ is phase value.

Every signal sample may be written according to Eq 3:

r I_θ=√(I²+Q²) tan⁻¹(Q/I). (Eq 3)

One way to calculate the average signal strengths, also known as RSSI_{avg}, for the received signal samples for the M samples is to use Eq 4

$${RSSI}_{avg} = ( 1 / M ) \sqrt{ } ( {\sum }_{m = 0}^{m = M - 1} {I ( m )}^{2} + {Q ( m )}^{2} ) \qquad ( Eq 4 )$$

An average circle for the constant amplitude type of modulated signal such as GMSK will be provided. This is shown as the circle in FIG. 1A and FIG. 1B.

A signal strength value, for each signal sample, m, also known as RSSIₘ, may be measured according to Eq 5 below:

RSSIₘ=√(Iₘ²+Qₘ²) (Eq 5)

There will be M such RSSIₘ, as there are M received signal samples. The normalized average signal strength value, also called RSSIₘ_{_}ₙₒᵣₘ, may be calculated by dividing RSSIₘ by RSSI_{avg} according to Eq 6.

RSSIₘ_{_}ₙₒᵣₘ=√(Iₘ²+Qₘ²)/RSSI_{avg} (Eq 6)

Action 304

The mobile station 201 calculates the standard deviation for the received signal samples. The standard deviation for the received signal samples indicates whether the signal samples are received will substantially the same signal strength as in FIG. 2A or if the signal strengths of the signal samples differ from each other as in FIG. 2B.

Generally, if the received signal samples are not affected by noise or interference signals then all the signal samples will be located very close to the average RSSI circle e.g. constant amplitude circle. The constellation diagram looks clean and the signal samples will be clustered around the unity circle as in FIG. 2A. When interference and noise power is increased in the received signal, as in FIG. 2B then the constellation diagram pattern will be more random and signal samples will be scattered around the axis of the constellation diagram. By measuring the scattering of the signal samples in the constellation diagram, the mobile station 201 may detect the presence of interference and noise signal in the received signal samples. The proportion of the scattering of the signal samples directly reflects the proportion of interference and noise power in the received signal samples.

The standard deviation of the amplitude of the signal samples may be measured from the average signal strength value, normalized to unity. RSSIₘ_{_}ₙₒᵣₘ is the normalized amplitude or normalized signal strength value for m-th signal sample. The standard deviation of the signal strength of each signal sample from the average signal strength value over a reception may be calculated according to Eq 7:

$$Std \text{-} deviation = Δ = \sqrt{1 / M} ( {\sum }_{m = 0}^{m = M - 1} {( 1 - {RSSI}_{m \_ norm} ( m ) )}^{2} \qquad ( Eq 7 )$$

The standard deviation Δ in equation (7) represents the interference from the second base station 230 and noise on the signal samples. The noise may be any kind of added unwanted signals.

The ideal relationship between the calculated standard deviation A and I+N is according to Eq 8:

Standard deviation (Δ)=β·(P_{interference+noise}/√M) (Eq 8)

Where P_{interference+noise} is the total noise and interference power present in the received signal and β is a constant factor, and the ideal value of β is one. For true GMSK signal, when no external interference I and noise N signal are present in the received signal, P_{interference+noise}=I+N=0, meanings the standard deviation value Δ is also zero. For practical system, the value of β may be derived empirically, by measuring the known value of P_{interference+noise} e.g. I+N corresponds to computed value of the standard deviation Δ.

Action 305

The mobile station 201 determines a ratio between the total signal strength received from the first base station 220 and interfering signals and noise from the at least one second base station 230. The ratio is determined based on a standard deviation for the received signal samples.

The mobile station 201 may calculate interfering signals and noise from the at least one second base station 230 by using a look up table to calculate the interfering signals and noise from the at least one second base station 230 based on the standard deviation for the received signal samples.

The mobile station 201 computes the RSSIₘ_{_}ₙₒᵣₘ (m) for each received signal sample using the Eq 5 above. The standard deviation directly represents the un-deserted signal proportion in the signal samples.

The calculated standard deviation value may be mapped to a C/(I+N) value using a reference table such as Table 1 below. The table may be defined using an empirical approach using simulation or any standard hardware platform. Another way to generate the table below may be to theoretically derive the β factor in equation 8 by using standard GMSK modulation properties and deriving the A value corresponding to various I+N values.

In the Table-1 below, the standard deviation is computed for different I+N values keeping the transmitted carrier power C constant at the first base station 220. That means the transmitted power is fixed, and I+N power is getting added in the channel over the air interface between the first base station 220 and mobile station 201.

TABLE 1
Std-deviation and C/(I + N) mapping

| Std-deviation value | C/(I + N) ratio |
|---|---|
| 0.7 | −5 dB |
| 0.5 | 0 dB |
| 0.2 | 20 dB |
| 0.1 | 40 dB |

Action 306

The mobile station 201 calculates the interfering signals and noise from the at least one second base station 230 based on the calculated sum of signal strengths for the received signal samples and the determined ratio.

The mobile station 201 may calculate the interfering signals and noise from the at least one second base station 230 by dividing the sum of signal strengths for the received signal samples with at least the determined ratio.

The interference and noise from the second base station 230 may be calculated as according to Eq 9:

I+N=RSSI_{avg}/(1+C/I+N). (Eq 9)

Action 307

The mobile station 201 calculates the signal strength of the signal from the first base station 220 based on the calculated interfering signals and noise from the at least one second base station 230 and the sum of signal strengths for the received signal samples.

The mobile station 201 may in some embodiments calculate the signal strength of the signal from the first base station 220 by subtracting the calculated interfering signals and noise from the at least one second base station 230 calculated in action 306 from the sum of signal strengths for the received signal samples.

This may be expressed according to Eq 10:

RSSIₜᵣᵤₑ=RSSI_{avg}−(I+N) (Eq 10)

Another way to calculate the signal strength of the signal from the first base station 220 may be according to Eq 11:

RSSIₜᵣᵤₑ=RSSI_{avg}−(I+N)=RSSI_{avg}−(standard deviation)·√M/β (Eq 11)

As the standard deviation represents the proportion of I+N, so that also indicates the quality of the received signal samples from the first base station 220. The lower the standard deviation, the higher the quality of the received signal samples. So, based on the estimated quality of the signal samples the measured first base stations 220 will be ranked for cell selection purpose. This will guarantee that at any particular time, the mobile station 201 is camped to the base station whose signal quality is best e.g. less affected by interference and noise signals.

This will be useful during idle mode when searching for the best suitable base station to camp on or best handover base station decision in dedicated mode.

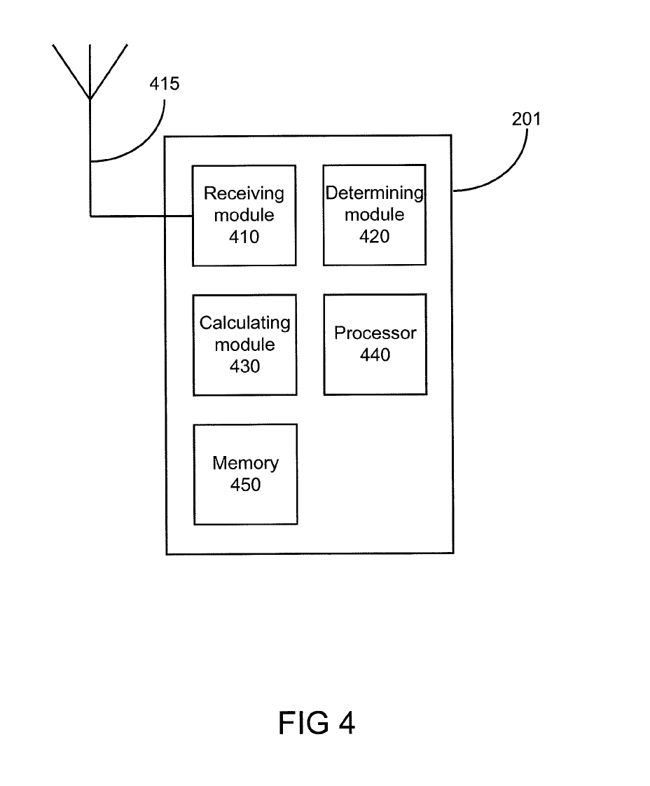

To perform the method steps described above for calculating a signal strength of a signal from a first base station 220, the mobile station 201 is configured, e.g. according to the arrangement depicted in FIG. 4.

The mobile station 201 is configured to receive the plurality of signal samples of the incoming signal, for example by means of a receiving module 410 within the mobile station 201. The signal samples may be received by the receiving module 410 via an antenna 415. The incoming signal comprises the signal from the first base station 220 and at least one signal from respective at least one second base station 230.

The mobile station 201 is further configured to, for example by means of a determining module 420 within the mobile station 201, determine the ratio between the total signal strength received from the first base station and interfering signals and noise from the at least one second base station 230. The ratio is determined based on the standard deviation for the received signal samples.

The mobile station 201 is further configured to, for example by means of a calculating module 430 within the mobile station 201, calculate the interfering signals and noise from the at least one second base station 230 based on the calculated sum of signal strengths for the received signal samples and the determined ratio.

The mobile station 201 is further configured to, for example by means of the calculating module 430 within the mobile station 201, calculate the signal strength of the signal from the first base station 220 based on the calculated interfering signals and noise from the at least one second base station 230 and the sum of signal strengths for the received signal samples.

The mobile station 201 is further configured to, for example by means of the calculating module 430 within the mobile station 201, calculate the sum of signal strengths for the received signal samples.

The mobile station 201 is further configured to, for example by means of the calculating module 430 within the mobile station 201, calculate the normalized signal strengths for the received signal samples based on the average signal strength for the received signal samples and using the normalized signal strengths for the received signal samples when calculating the standard deviation.

The mobile station 201 is further configured to, for example by means of the calculating module 430 within the mobile station 201, calculate the standard deviation for the received signal samples.

The mobile station 201 is further configured to, for example by means of the calculating module 430 within the mobile station 201, calculate the interfering signals and noise from the at least one second base station 230 by dividing the sum of signal strengths for the received signal samples with at least the determined ratio.

The mobile station 201 is further configured to, for example by means of the calculating module 430 within the mobile station 201, calculate the signal strength of the signal from the first base station 220 by subtracting the calculated interfering signals and noise from the at least one second base station 230 from the sum of signal strengths for the received signal samples.

The mobile station 201 is further configured to, for example by means of the calculating module 430 within the mobile station 201, calculate the interfering signals and noise from the at least one second base station 230 by using a look up table to calculate the interfering signals and noise from the at least one second base station 230 based on the standard deviation for the received signal samples.

The embodiments herein handling the process of calculating the signal strength of a signal from a first base station 220 may be implemented through one or more processors, such as the processor 440 in the mobile station 201 depicted in FIG. 4, together with computer program code for performing the functions and actions of the embodiments herein. The program code mentioned above may also be provided as a computer program product, for instance in the form of a data carrier carrying computer program code for performing the embodiments herein when being loaded into the in the mobile station 201. One such carrier may be in the form of a CD ROM disc. It is however feasible with other data carriers such as a memory stick. The computer program code may furthermore be provided as pure program code on a server and downloaded to the mobile station 201.

The mobile station 201 may further comprise a memory 450 comprising one or more memory units. The memory 450 is configured to be used to store, data, configurations, schedulings, and applications to perform the methods herein when being executed in the mobile station 201.

Those skilled in the art will also appreciate that the communication receiving module 410, the determining module 420, and the calculating module 430, may refer to a combination of analog and digital circuits, and/or one or more processors configured with software and/or firmware, e.g. stored in the memory 450, that when executed by the one or more processors such as the processor 440 as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above-described preferred embodiments. Various alternatives, modifications and equivalents may be used. Therefore, the embodiments should not be taken as limiting the scope of the invention, which is defined by the appending claims.

1. A method in a mobile station for calculating a signal strength of a signal from a first base station, the method comprising:
receiving a plurality of signal samples of an incoming signal, which incoming signal comprises a signal from the first base station and at least one signal from respective at least one second base station;
determining a ratio between the total signal strength received from the first base station and interfering signals and noise from the at least one second base station, wherein the ratio is determined based on a standard deviation for the received signal samples;
calculating the interfering signals and noise from the at least one second base station based on a calculated sum of signal strengths for the received signal samples and the determined ratio; and
calculating the signal strength of the signal from the first base station based on the calculated interfering signals and noise from the at least one second base station and the sum of signal strengths for the received signal samples.

2. The method according to claim 1, further comprising:
calculating a sum of signal strengths for the received signal samples.

3. The method according to claim 1, further comprising:
calculating a normalized signal strengths for the received signal samples based on an average signal strengths for the received signal samples RSSI and using the normalized signal strengths for the received signal samples when calculating the standard deviation.

4. The method according to claim 1, further comprising:
calculating a standard deviation for the received signal samples.

5. The method according to claim 1, wherein calculating the interfering signals and noise from the at least one second base station is performed by dividing the sum of signal strengths for the received signal samples with at least the determined ratio.

6. The method according to claim 1, wherein calculating the signal strength of the signal from the first base station is performed by subtracting the calculated interfering signals and noise from the at least one second base station from the sum of signal strengths for the received signal samples.

7. The method according to claim 1, wherein calculating the interfering signals and noise from the at least one second base station is performed by using a look up table to calculate the interfering signals and noise from the at least one second base station based on the standard deviation for the received signal samples.

8. A mobile station for calculating a signal strength of a signal from a first base station, wherein the mobile station is configured to:
receive a plurality of signal samples of an incoming signal, which incoming signal comprises a signal from the first base station and at least one signal from respective at least one second base station;
determine a ratio between the total signal strength received from the first base station and interfering signals and noise from the at least one second base station, wherein the ratio is determined based on a standard deviation for the received signal samples;
calculate the interfering signals and noise from the at least one second base station based on a calculated sum of signal strengths for the received signal samples and the determined ratio; and
calculate the signal strength of the signal from the first base station based on the calculated interfering signals and noise from the at least one second base station and the sum of signal strengths for the received signal samples.

9. The mobile station according to claim 8, wherein the mobile station is further configured to:
calculate a sum of signal strengths for the received signal samples.

10. The mobile station according to claim 8, wherein the mobile station is further configured to:
calculate a normalized signal strengths for the received signal samples based on an average signal strength for the received signal samples and using the normalized signal strengths for the received signal samples when calculating the standard deviation.

11. The mobile device according to claim 8, wherein the mobile station is further configured to:
calculate a standard deviation for the received signal samples.

12. The mobile device according to claim 8, wherein the mobile station is further configured to calculate the interfering signals and noise from the at least one second base station by dividing the sum of signal strengths for the received signal samples with at least the determined ratio.

13. The mobile device according to claim 8, wherein the mobile station is further configured to calculate the signal strength of the signal from the first base station is further adapted to calculate the signal strength of the signal from the first base station by subtracting the calculated interfering signals and noise from the at least one second base station from the sum of signal strengths for the received signal samples.

14. The mobile device according to claim 8, wherein the mobile station is further configured to calculate the interfering signals and noise from the at least one second base station by using a look up table to calculate the interfering signals and noise from the at least one second base station based on the standard deviation for the received signal samples.

15. A nontransitory computer readable storage medium comprising software code portions adapted for performing a method when executed on a processor, wherein the method is for calculating, in a mobile station, a signal strength of a signal from a first base station, wherein the method comprises:
receiving a plurality of signal samples of an incoming signal, which incoming signal comprises a signal from the first base station and at least one signal from respective at least one second base station;
determining a ratio between the total signal strength received from the first base station and interfering signals and noise from the at least one second base station, wherein the ratio is determined based on a standard deviation for the received signal samples;
calculating the interfering signals and noise from the at least one second base station based on a calculated sum of signal strengths for the received signal samples and the determined ratio; and
calculating the signal strength of the signal from the first base station based on the calculated interfering signals and noise from the at least one second base station and the sum of signal strengths for the received signal samples.
